(19) United States
(12) Patent Application Publication
(10) Pub. No.: US 2016/0199842 A1
(43) Pub. Date: Jul. 14, 2016

(54) MINERAL BREAKER

(71) Applicant: MMD DESIGN & CONSULTANCY LIMITED, Somercotes, Derbyshire (GB)

(72) Inventor: Richard Paul BARBER, Nottingham (GB)

(73) Assignee: MMD Design & Consultancy Limited, Somercotes (GB)

(21) Appl. No.: 14/914,626

(22) PCT Filed: Aug. 29, 2014
(86) PCT No.: PCT/GB2014/052617

§ 371 Date: Feb. 25, 2016

(30) Foreign Application Priority Data
Aug. 30, 2013 (GB) 1315451.3

(51) Int. Cl. B02C 4/42; B02C 2/00; B02C 1/02

(52) U.S. Cl. CPC B02C 4/42; B02C 1/02; B02C 2/00

(57) ABSTRACT

A mineral breaker is described having a breaker unit (1) with at least one rotary drive shaft (15), a rotary electric motor (13), and a drive gear box (17). The breaker unit drive shaft is coupled for rotation to an output shaft of the drive gear box, the rotary electric motor is coupled to rotatably drive an input shaft of the main drive gear box. The rotary electric motor is a switched reluctance motor.

The present invention relates to mineral breaking/sizing and in particular to a drive apparatus for a mineral breaker/sizer and to a mineral breaker/sizer with such a drive apparatus.

Mineral breakers are known in which a breaking action is effected by feeding mineral to an apparatus comprising a breaker unit that is driven by a rotary drive apparatus and configured to break down the mineral fed into the breaker unit for example to a desired size by action of breaker elements within the breaker unit driven directly or indirectly via at least one breaker unit drive shaft powered by the rotary drive apparatus. Breaker units envisaged for application of the invention include primary, secondary and tertiary crushers for the breaking and in particular the sizing of minerals.

A typical known breaker unit might comprise a plurality of elongate breaker assemblies rotatably mounted in a frame housing with their axes parallel and carrying breaking formations such as breaker teeth. A typical breaker assembly comprises a rotatable shaft carrying a drum provided with breaking teeth projecting outwardly and generally substantially radially therefrom. These breaker teeth interact to restrict the passageway between the breaker assemblies such that oversized lumps of mineral are prevented from passing therethrough. Rotation of the breaker assemblies powered by the rotary drive apparatus tends to break down these oversized lumps of mineral, for example by a snapping action as they are gripped between teeth of adjacent breaker assemblies or by a combined action, in that tensile, compressive and shear loadings are created to cause the mineral to fracture.

For example such drums might have relatively large teeth co-operating on the opposed drums to break mineral lumps down. Opposed drums are typically configured to be, though not limited to be, contrarotating, and may rotate in either sense relative to the frame. During operation, mineral breaking for reducing the material to a required size may occur both between the teeth on the opposed drums and between the teeth of a drum and a side wall of the housing. Additional structures may be provided mounted upon or contiguous with the side wall of a housing to facilitate breaking and sizing at this point, for example in the form of additional toothed structures projecting inwardly from the side wall.

The present invention is in particular directed to breaker units formed with a plurality of elongate breaker assemblies rotatably mounted with parallel axes, and is discussed herein in that context, but is not limited to such breaker units but applicable to any breaker unit powered by a rotational drive.

In a typical rotational drive system, a rotary AC electric induction motor is used to drive the rotation of one or more breaker shafts via a main drive gear box configured to produce the appropriate gear ratio between the rotary electric motor and the shaft. To accommodate the substantial mechanical stresses that can be generated by the breaker operation it is usual, particularly for higher power applications and for the breaking of harder minerals, to couple the induction motor to an input shaft of the main drive gear box via a fluid coupling. A rigid mechanical coupling typically connects each breaker shaft to its output shaft of the main drive gear box.

Rotary AC electrical induction motors as a means to delivery power to rotationally driven breakers and sizers offer an effective solution that meets many of the particular requirements of breaking and sizing applications, and their use has become extremely widespread for a range of breakers/sizers, and in particular for those comprising a plurality of parallel rotatable breaker drums. However, the arrangement is not without its problems.

The torque delivered by a rotary AC electric induction motor can vary substantially with rotational speed. This can limit the range of speeds over which effective operation is possible.

Moreover, the torque attributable to rotor inertia in a rotary AC electric induction motor is substantial in proportion to the overall delivered torque. If the drive shaft of the induction motor couples via a direct drive system through the main drive gear box to the drive train and crusher unit beyond, this inertia feeds directly through to the gear box and in rigid manner to the machine. Except at low power or with soft materials, this uncontrolled torque attributable to rotor inertia may to lead to considerable problems. There is no ability to accommodate it in the rigid drive train. Resultant stresses could break the machine. For this reason, it is common to include a torque limiting coupling, and in particular a fluid coupling, to mitigate the effect of uncontrolled torque attributable to rotor inertia feeding through to the gear box and to the rest of the drive train.

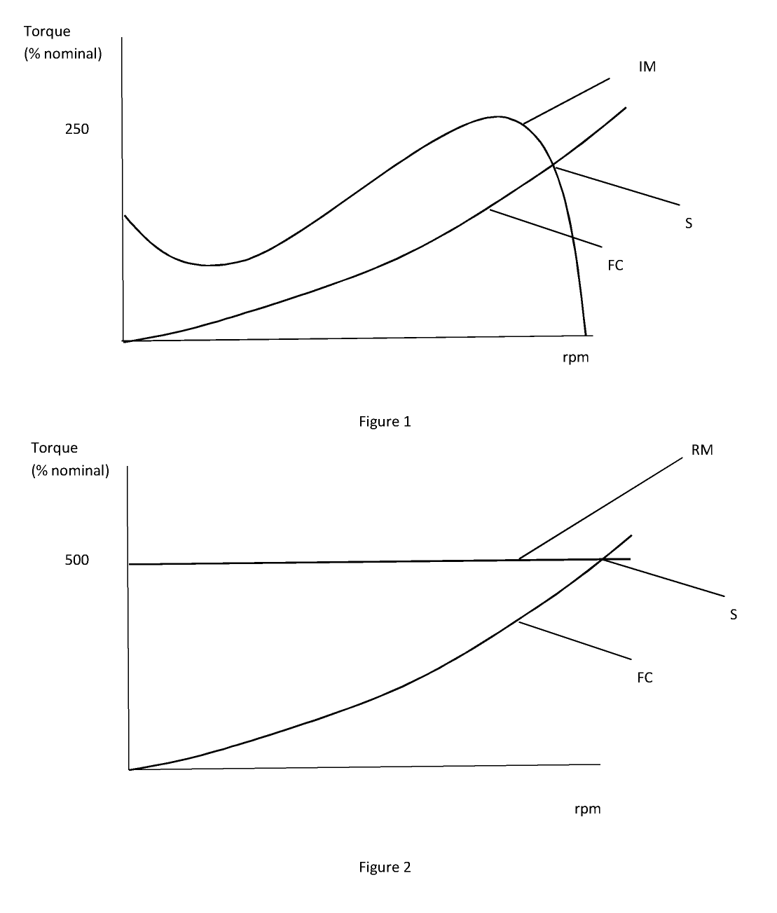

The general principles of operation of such a system can be considered with reference to the simple schematic of FIG. 1. A typical torque delivery curve, showing overhead torque as a percentage of rated nominal versus rotational speed, is shown for a typical induction motor (IM). A typical torque response with rotational speed for a fluid coupling rated and sized for use with the example motor is shown by the curve (FC). The precise profile of the torque curve for the fluid coupling (FC) is determined by its rated design, and can be adjusted by adjusting its fluid fill.

As can be seen from the very general schematic in FIG. 1, a fundamental feature of the different torque responses of the motor and the fluid coupling is that it produces a stable and synchronous condition at the point (S). This is the speed at which the induction motor and fluid coupling combination delivers stable drive to the gear box.

For stable operation, a typical system design will be such as to operate the induction motor in the breakdown zone beyond the peak, but as near to the peak as practical. The motor and fluid coupling are designed with this principle in mind to determine a suitable position on the curve for synchronous operation (S). For a typical mineral breaker application, a rotational speed of 1500 rpm might be appropriate.

The use of the fluid coupling, which has much reduced inertia relative to the induction motor, reduces the uncontrolled torque attributable to inertia delivered to the gear box to a substantial degree, sufficient to deliver at safe levels under operation at optimum speed.

A further advantage of the use of a fluid coupling is that it accommodates shock loads which might otherwise be generated at the breaker under transient conditions and transmitted through the rigid drive train in damaging manner. The fluid coupling gives a degree of rotary torsional tolerance to the system.

However, the use of a fluid coupling compounds the already limited delivery range of the induction motor by effectively limiting delivery to a single synchronous condition which is fixed once set by the combination design.

Alternative drives which could deliver the drive requirement of a breaker unit and in particular drives which could deliver the drive requirement of a breaker unit while mitigating some or all of the above disadvantages might be desirable.

Thus, in accordance with the invention in a most general aspect, a mineral breaker comprises a breaker unit having at least one rotary drive shaft and configured such that rotation of the drive shaft in use will tend to break down mineral fed into the breaker unit for example to a desired size, a rotary electric motor, and a drive gear box; wherein the breaker unit drive shaft is coupled for rotation to an output shaft of the drive gear box, the rotary electric motor is coupled to rotatably drive an input shaft of the main drive gear box, and the rotary electric motor is a switched reluctance motor.

At its broadest, the invention can be seen to apply to, and provide the rotary drive for, a breaker unit of any configuration that is driven by a rotary drive apparatus and configured to break down mineral fed into the breaker unit, for example to desired size, by action of breaker elements within the breaker unit driven directly or indirectly via at least one breaker unit drive shaft. The invention is distinctly characterised at its broadest in that the drive shaft is powered by a rotary drive apparatus which includes a switched reluctance motor instead of a conventional induction motor.

This represents a radical departure from the long established practice in relation to breaker/crusher technology to rely on a rotary AC electric induction motor to provide the rotary drive for a breaker unit. Once this departure is made, a number of potential advantages can accrue.

In particular, a desirable feature of such a motor is the ability to deliver much increased overhead torque. An extremely large overhead torque relative to comparable induction motor is offered (compare FIGS. 1 and 2 for example). A reluctance motor is preferably used that is configured to deliver overhead torque of at least 500% of nominal, and in the preferred case up to 750% of nominal. It would generally be accepted that an induction motor is unlikely to deliver an overhead torque of much more than 250% nominal.

Further advantages may include without limitation some or all of the following.

Using a switched reluctance motor offers the potential of using a smaller motor frame size to generate more torque than an existing larger frame size induction motor (eg an SR motor in 132 KW frame will generate the torque of a 300 KW induction motor).

A high degree of torque control may be achieved by user programming.

Cheaper running costs are likely—an SR Motor is even more efficient than any other motor/starter combination currently available. Operation with reduced size generators is possible.

Electrical inrush load is essentially eliminated. The motor generates reduced stator temperature.

The overall cost is likely to be reduced.

Generally, as will be familiar, the switched reluctance motor is configured to include a stator comprising a plurality of fixed projecting (salient) poles and a rotor including a plurality of rotating projecting (salient) poles facing generally towards the plurality of fixed salient poles.

More specifically, the stator is typically configured with a plurality of fixed salient poles formed to protrude at predetermined circumferential intervals with coils wound around each of the fixed salient poles.

The rotor consists of soft magnetic material, such as laminated silicon steel, which has multiple projections acting as salient magnetic poles via a magnetic reluctance mechanism.

When a stator pole is energised, a rotor torque is generated in the direction that will reduce reluctance.

For switched reluctance motors, the number of rotor poles is typically less than the number of stator poles. For example in a possible embodiment the switched reluctance motor has stator poles and rotor poles in a 3:2 ratio and for example has six stator poles and four rotor poles.

FIG. 2 illustrates in simple schematic form a typical plot of overhead torque versus rotational speed for a typical switched reluctance motor (RM), for comparison purposes with the similar simple schematic of FIG. 1. Again, overhead torque is plotted as a percentage of nominal rating.

Several of the advantages of using a switched reluctance motor are apparent from this simple schematic. In particular, it can be seen that a switched reluctance motor is capable of delivering a much higher overhead torque to nominal rating relative to a comparable induction motor. For example, an overhead torque of 500% to nominal is typically achievable. By contrast, with an induction motor, even in the desired area of operation illustrated in FIG. 1,250% or lower might be more typical.

Also, the torque delivered by the motor is essentially constant with rotational speed. It does not show the more complex varying profile of the induction motor illustrated in FIG. 1.

The illustration in FIG. 2 also includes a torque response curve for a fluid coupling (FC). As was the case with the system represented in FIG. 1, a fluid coupling might be used to reduce the uncontrolled torque attributable to rotor inertia delivered to the main gear box and to the otherwise relatively torsionally stiff drive train, preventing damage to the drive system. The presence of such a fluid coupling means that the torque attributable to inertia delivered in the system is dependent upon the inertia of the fluid coupling, and not that of the switched reluctance motor rotor.

As can be seen in the simple schematic representation of FIG. 2, the two torque plots still deliver an intersection point which will represent the point of synchronous operation of the motor/coupling system. This will be selected in accordance with the design application, but as previously noted for a typical crusher might be 1500 rpm.

An advantage offered by the switched reluctance motor is that it becomes relatively easy to design a fluid coupling to make the intersection, because the response of the switched reluctance motor itself is relatively constant and consistent. By contrast, the variable response of an induction motor and the requirement to keep synchronous operation in the breakdown zone can make the design of compatible torque profiles in motors and couplings a more significant problem.

Further yet in some cases a particular and surprising advantage has been identified in making the substitution of a switched reluctance motor for a conventional induction motor. Subject in particular to appropriate torque and inertia control, which is within the competence of the skilled person by appropriate design of the switched reluctance motor, it may become possible to contemplate dispensing with the fluid coupling that is provided in many prior art systems to protect the breaker unit, typically between the induction motor and the main drive gear box, altogether and thus obviate some of the limitations considered in the discussion of FIGS. 1 and 2 above.

The invention is thus not merely substitution of one electric rotary motor for another without additional functionality. It confers a significant potential additional functionality, via the opportunity provided by careful engineering of the operational parameters of the switched reluctance motor to control the torque delivered by the motor, to simplify and improve the overall power train design, in particular by providing for simpler design of the fluid coupling between the motor and the main gear box, or in some instances even dispensing with it altogether, and thereby addressing the disadvantages which may accrue from complex prior art fluid coupling arrangements.

It follows that in a possible preferred embodiment of the invention, this fluid coupling is dispensed with. Accordingly, in such a preferred embodiment, a rotary shaft of the switched reluctance motor and an input shaft of the main drive gear box are coupled together for rotation without the use of a fluid coupling. Accordingly, in such a preferred embodiment, a rotary shaft of the switched reluctance motor and an input shaft of the main drive gear box are coupled together for rotation directly mechanically, and for example via a direct mechanical coupling such as a rigid mechanical coupling.

Some discussion of the advantages of designs embodying such a direct drives system follows. It should be understood that such designs are an optional embodiment illustrative of the particular functionality conferred by use of a reluctance motor. The invention is not limited to direct drive systems, and the modification or removal of a fluid coupling may not be appropriate in all design scenarios. Accordingly, in an alternative embodiment, a rotary shaft of the switched reluctance motor and an input shaft of the main drive gear box are coupled together for rotation by an arrangement that includes a fluid coupling.

A possible desirable feature of using a direct drive system rather than a fluid coupling is that operation is no longer limited to the synchronous case. The substantial additional overhead torque that a reluctance motor can deliver is made available across the entire speed range of the motor. A number of further potential operational advantages can accrue.

In particular, through variable speed control (by fixed programmed set point), it is possible to vary the final speed of the sizer shafts. There is the potential for increased throughput, slow down to improve machine grip, slow down to stop belt surge, adjust speed to reduce teeth wear rate, etc. An effectively unlimited number of starts per hour can be made. In the event of a stall can switch from forward to reverse operation and back again very quickly, controlling the motor. None of these advantages are available with synchronous operation using a fluid coupling.

It is not immediately inherent from the use of a switched reluctance motor that the fluid coupling can be simplified or dispensed with. The main purpose of the fluid coupling is to reduce the substantial uncontrolled torque attributable to rotor inertia which would be present if the rotor of the electric motor were used directly to drive the gear box and breaker shafts. With such a fluid coupling present, the torque attributable to inertia is a function of the inertia of the coupling and not of the rotor shaft. An appropriate coupling design can be used to reduce the inertial torque to a satisfactory degree.

In a typical induction motor, it might be necessary to step down the inertial torque by as much as a factor of 3 or more. For example, in a known design, an induction motor rotor with an inertia of 3.2 kg m⁻² is used in conjunction with a fluid coupling with an inertia of 1.17 kg m⁻².

A typical reluctance motor design has a rotor inertia that is lower than a typical equivalent induction motor design, perhaps by as much as a half, but this is not generally sufficient to address the problem that the fluid coupling addresses in prior art induction motor systems. A mere replacement of a standard induction motor by a standard off the shelf reluctance motor of equivalent power would not generally allow the fluid coupling to be dispensed with.

However, it is an additional advantage of the use of reluctance motors that a reluctance motor allows modification of the rotor inertia in a way that would not be possible on an induction motor. In an induction motor, power is essentially scalable only by increased motor size, and in particular by increased rotor size. Higher torque necessarily corresponds to higher inertia. A switched reluctance motor does not need to be scaled in this way. Because of the principles of motor design, it is possible to modify a design to deliver the required torque with reduced rotor inertia. It is possible to modify a standard design for example by using a longer motor with a thinner, and hence lower inertia, rotor. With careful design, the switched reluctance motor can be modified to deliver the required torque with inertia kept at the required level to allow the fluid coupling to be dispensed with in a way which would not be possible in an induction motor.

This potentially significant simplification of the design is thus offered, subject to appropriate design of switched reluctance motor for appropriate inertia control, for a wide range of breaker unit designs and sizes which could not realistically be contemplated when a rotary electric induction motor was being used, and where a fluid coupling was likely to be necessary in the majority of design situations. It is not an inevitable consequence of using a switched reluctance motor. The person skilled in the art is still likely to consider, given the long held paramount requirements to protect the breaker unit from the high loads involved in operation, and from the uncontrolled torque attributable to rotor inertia in particular, that a fluid coupling is likely to be required. Without careful design of the switched reluctance motor and the provision of substantial torque control and inertia reduction, this is likely still to be true. However, the invention in accordance with this preferred embodiment lies in the realisation that it is possible to achieve such high levels of torque control and inertia reduction with switched reluctance motors, and that once this possibility is appreciated, the achievement of such control is within the competence of the skilled person with suitable careful design.

In particular, a switched reluctance motor should be provided with increased torque control and decreased inertia. This may require a degree of bespoke motor design depending on the particular loading applications which will be within the competence of the skilled person. Increased torque control may be achieved through suitable control systems. Decreased inertia for a given requirement could be achieved by using a smaller diameter, longer rotor design or through a reduction in rotor mass.

In a conventional prior art design, the fluid coupling had two purposes in particular. First, it served to protect the breaker system against excessive levels of uncontrolled torque attributable to rotor inertia in the motor. Second, it provided a degree of protection against shock loading of the breaker by introducing some torsional slippage into an otherwise torsionally very rigid system.

As has been set out above, it is possible, by careful design of the switched reluctance motor to reduce rotor inertia, to obviate the requirement for the first function of the fluid coupling. It may still be desirable to provide a means to perform the second function, and to impart a degree of rotary torsional tolerance into what is otherwise a rigid and stiff drive system, for example to accommodate shock loads.

In a possible further modification to the system in a preferred embodiment of the invention, for example to compensate to some extent for the removal of the protection conferred in a prior art design by the fluid coupling, a compliant coupling is preferably provided between a drive shaft of the breaker unit and its corresponding output shaft of the main gear box. This is intended to give some degree of tolerance. This compliant coupling substitutes for the rigid coupling typically provided in current designs. This is intended to give some degree of rotary torsional tolerance.

The compliant coupling is preferably a resilient mechanical coupling. The compliant coupling is preferably a grid coupling.

Such grid coupling assembly for example comprises in familiar manner a first hub and a second hub to be connected respectively to one of the shafts to be coupled for rotation, for example comprising flanged hubs with slots or grooves in the flanges, connected by a mechanical flexibly resilient element, typically a serpentine element such as a serpentine spring.

A mineral breaker in accordance with the invention comprises a breaker unit that is configured to break down the mineral fed into the breaker unit for example to a desired size by action of breaker elements within the breaker unit driven directly or indirectly via the at least one breaker unit rotary drive shaft. Breaker units envisaged for application of the invention include primary, secondary and tertiary crushers for the breaking and in particular the sizing of minerals. Breaker units envisaged for application of the invention include roller crushers, jaw crushers, cone crushers. It can be seen that application of the invention could be considered with a breaker unit of any such configuration provided that the breaking action is configured to be driven in use by the at least one breaker unit rotary drive shaft.

However the invention is particularly applicable in the preferred case to a breaker unit comprising one or more breaker rollers having shafts mounted for rotation for example in a frame housing and structured such that rotation of the breaker roller shafts in use tends to break down mineral, for example under the action of breaking formations such as breaker teeth carried on the breaker rollers and/or associated structures.

A typical known breaker unit might comprise a plurality of elongate breaker assemblies rotatably mounted for rotation with their axes parallel and carrying breaking formations such as breaker teeth.

Thus for example a breaker apparatus such as a sizer apparatus comprises a plurality of breaker assemblies mounted for rotation with their axes parallel, each breaker assembly for example comprising a rotatable shaft carrying outwardly and for example circumferentially projecting breaking formations such as breaker teeth; and a rotational drive system to drive the shafts as above described.

These breaker teeth interact to restrict the passageway between the breaker assemblies such that oversized lumps of mineral are prevented from passing therethrough, but additionally serve to break down these oversized lumps of mineral, for example by a snapping action as they are gripped between teeth of adjacent breaker assemblies. The said plurality of breaker assemblies may be mounted alongside one another in a frame housing for example.

Optionally, further projections may be provided, in the form of breaker teeth or otherwise, projecting from side walls of the housing or from the base of the housing towards the breaker assemblies to assist in sizing and/or breaking. In particular for example if a pair of drums rotate outwardly when viewed from above, breaker teeth provided in the side walls may be useful to assist in breaking. Optionally additionally or alternatively, an adjacent pair of breaker assemblies may provided with an elongate breaker bar extending longitudinally in a direction parallel to the axes of the breaker assemblies, the breaker bar being located with its longitudinal axis positioned between and beneath the axes of rotation of the breaker assemblies, the breaker bar including a plurality of breaker teeth spaced along its length. In particular for example if a pair of drums rotate inwardly when viewed from above, such a breaker bar may be useful to assist in breaking.

In the simplest embodiment, a breaker unit comprises exactly two parallel breaker assemblies within a housing. In alternative embodiments, more than two breaker assemblies may be provided. Where more than two breaker assemblies are provided these may be provided within a common housing, or within further housings. For example, in accordance with a possible embodiment, two or more pairs of breaker assemblies, each within a respective housing, are disposed together with their rotation axes aligned.

Adjacent pairs of breaker assemblies may be mounted to be rotatably driven in the same direction or in contrarotating directions. Where adjacent pairs are contrarotating, they may be driven to rotate inwardly towards each other or outwardly from each other when viewed from able. Examples of all such arrangements will be known from the prior art. This embodiment of the invention encompasses drums mounted for rotation in either direction in any combination, and depending on application it may be desirable to have adjacent drums contra-rotating or rotating in the same direction, and where three or more drums are provided to have adjacent pairs rotating in either or both senses.

A breaker assembly may be of monolithic construction but is more typically an assembly of components, for example comprising an elongate body on which tooth carrying structures and/or teeth may be mounted to complete the assembly. In a convenient embodiment, a breaker assembly comprises a breaker shaft with a plurality of toothed annuli mounted on the breaker shaft, adjacent annuli being axially spaced along the shaft, each annulus being fixedly connected to the shaft.

Preferably each toothed annulus includes an annular boss and one or more rows of teeth spaced circumferentially about the boss, each tooth extending generally radially from the boss. Each toothed annulus may be a unitary metal casting or forging or profile cut from metal plate wherein the teeth are integrally joined with the annular boss.

Each tooth may define a breaker tooth per se. Alternatively each tooth may define an inner core or horn of a breaker tooth wherein the outer shape of the breaker tooth is defined by a tooth sheath or wear plates secured to the horn, or comprises welded layers of wear resistant material built up on the horn.

In accordance with the above embodiments of breaker drum assembly, and in other embodiments not specifically exemplified above, a breaker unit may be configured to break down the mineral fed into the breaker unit by action of a plurality of breaker elements provided with a respective plurality of drive shafts. In a possible embodiment, a separate motor may be provided to drive each drive shaft, for example via a separate main drive gear box. Alternatively, a single drive system may be provided to drive more than one breaker shaft. For example, a single switched reluctance motor may be coupled to a single input shaft of a main drive gear box which is provided with a plurality of output shafts to drive a plurality of breaker unit drive shafts, and for example all of such breaker unit drive shafts, in particular in the preferred manner and via the preferred couplings above described.

Where a single drive system is provided to drive plural breaker unit drive shafts it will be necessary to provide some means to transfer drive to the plural breaker shafts. Also, in particular but not limited to the case where a single drive is provided, it might be desirable to time the rotation of plural shafts together. In a possible modification, spur gears may be provided in association with each of a plurality of breaker shafts of a respective plurality of breaker units, for example mounted on the respective breaker shafts, to transfer drive between shafts and/or to couple and time their respective rotations.

In a possible arrangement, an extended portion of each breaker shaft carries a spur gear to transfer drive between the respective shafts and/or to co-ordinate the timing of the rotation of the respective shafts. For example a discrete enclosed volume is provided on the breaker between a working area where the plurality of breaker units are located and the main drive gearbox, an extended portion of each breaker shaft passes into this volume, and spur gears are provided within this enclosed volume carried on respective extended portions of the plurality of breaker shafts.

In an alternative possible arrangement, a timing gearbox having a plurality of output shafts coupled to drive each of a plurality of breaker shaft and at least one input shaft driven by a main gearbox is provided, containing within an enclosed gearbox volume a timing gear assembly comprising mutually engaging spur gears to co-ordinate the rotation of the said output shafts.

A suitable timing gear assembly might for example comprise a gear shaft for each breaker shaft extending to an output shaft external of the timing gear box coupled with the breaker shaft, the gear shafts associated with each of a respective set of breaker shafts to be timed together carrying mutually engaging spur gears.

In all cases the timing gear arrangement preferably consists of mutually engaging spur gears with a 1:1 ratio, whether placed in a discrete gear box linked to the respective breaker shafts via a suitable coupling or carried directly upon the breaker shafts.

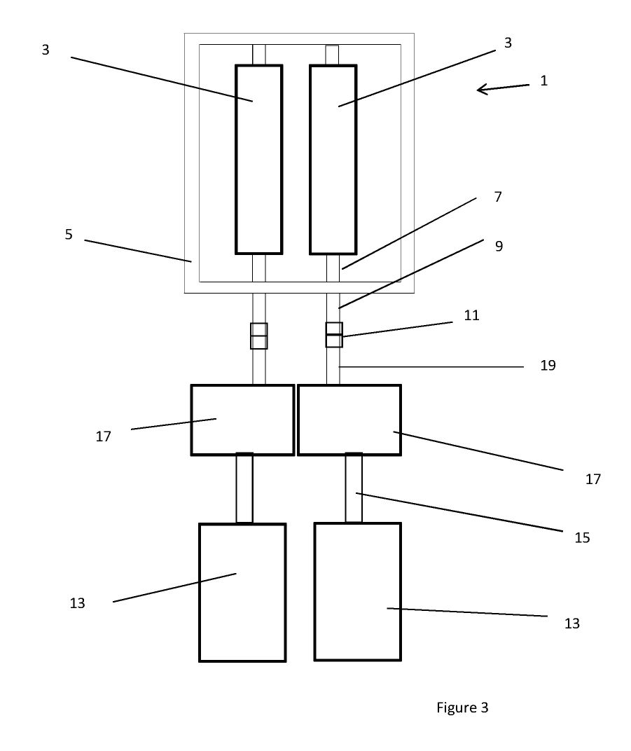

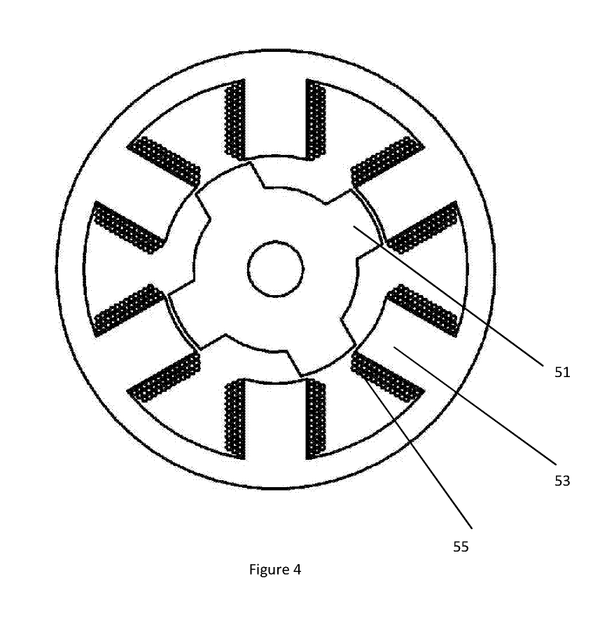

The Invention will now be described by way of example only with reference to the accompanying drawings, in which: FIGS. 1 and 2 are graphical representations of operational considerations encountered in the field of the invention as discussed above; FIG. 3 illustrates an embodiment of the invention in plan view FIG. 4 is a cross-section illustrating the principle of the reluctance motor.

Referring to FIG. 3, a mineral sizer is shown comprising a breaker unit (1) made up of a pair of breaker drum assemblies (3). The breaker drum assemblies are shown purely schematically in FIG. 1, but in use will comprise a roller carrying a plurality of outwardly extending breaker teeth.

The breaker drum assemblies (3) are mounted for rotation within a frame housing (5) for rotation by rotation of the shafts (7) in familiar manner. In use, mineral is sized in the usual way in that the breaker teeth interact to restrict the passageway in between the breaker assemblies such that oversized lumps of mineral are prevented from passing through, but act on such oversized lumps mineral to break them down until they are sized to pass through. Additional projections (not shown) may be provided depending from an inner wall of the side walls of the housing (5) to assist in the sizing and/or breaking operation.

These structures will be familiar from conventional designs of sizer, and although an embodiment of sizer is shown consisting of exactly two breaker assemblies, the skilled person will have no problems applying principles of the invention to other arrangements.

Each breaker assembly is rotationally driven via a drive system consisting of an electric motor (13), shaft (15), and main gear box (17). The apparatus is distinctly characterised in that the drive shaft (15) is powered by a switched reluctance motor (13) instead of a conventional induction motor.

A simple schematic illustrating the principle of the reluctance motor is shown in FIG. 4. FIG. 4 shows a schematic cross-section of an example arrangement with six fixed salient stator poles (53) formed to protrude at regularly spaced circumferential intervals wound with coils (55) and a four pole rotor (51). This is for illustration of the principle. Preferred numbers and arrangements of rotor and stator poles is a matter for individual design requirement. In particular and arrangement with six stators and a four pole rotor is merely a possible embodiment of the invention.

In the illustrated embodiment, the apparatus is further distinctive in that the switched reluctance motor (13) is coupled to an input shaft of the main gear box (17) by a direct mechanical coupling. The fluid coupling routine found in prior art systems is dispensed with. For illustrative purposes, the drive shaft (17) is shown integrally forming an input shaft for the main gear box. In practice a rotary shaft of the switched reluctance motor and an input shaft of the main drive gear box may be discrete elements coupled together for rotation directly mechanically, and for example via a direct mechanical coupling such as a rigid mechanical coupling.

A compliant coupling (11) is provided between a rearward extension (9) of the drive shaft (7) of the breaker assembly and its corresponding output shaft (19) of the main gear box (17). This is intended to give some degree of tolerance. The compliant coupling in the embodiment comprises a Bibby Coupling.

Particular advantages of the design using a switched reluctance motor with appropriate torque and inertia control, dispensing with the fluid coupling between the motor and main gear box, and instead adding a simple compliant mechanical coupling between the breaker unit drive shaft and its corresponding output shaft of the main gear box are discussed below.

In the illustrated embodiment, a separate motor (13) is provided to drive each breaker assembly (1). It is an advantage of the present invention that alternative arrangements are made more practical. For example, a single drive system might be provided to drive more than one driver assembly. For example in relation to the illustrated embodiment therefore, a single drive system leading to a single main drive gear box (17) may be provided.

In a possible modification, spur gears (not shown) may be provided, for example on the breaker shafts, to transfer drive between multiple shafts and/or to couple and time their respective rotations.

In the alternative, the invention would also allow, by provision of a suitable selective transmission system which would be comfortably within the competence of the skilled person, for both breaker assemblies to be optionally driven by a single drive, or alternatively to be driven by their respective drives, for example if one of the drives was unserviceable.

Although the illustrated embodiment is discussed in the context of a sizer with exactly two breaker assemblies and exactly two drive assemblies, the principles could readily be applied to other breaker/drive assembly arrangements.

1. A mineral breaker comprising:
a breaker unit comprising at least one rotary drive shaft, a rotary electric motor, and a drive gear box; and
wherein the breaker unit drive shaft is coupled for rotation to an output shaft of the drive gear box, the rotary electric motor is coupled to rotatably drive an input shaft of the main drive gear box, and the rotary electric motor is a switched reluctance motor.

2. A mineral breaker in accordance with claim 1 wherein a rotary shaft of the switched reluctance motor is coupled to rotatably drive an input shaft of the main drive gear box without the use of a fluid coupling.

3. A mineral breaker in accordance with claim 1 wherein a rotary shaft of the switched reluctance motor and an input shaft of the main drive gear box are coupled together for rotation directly mechanically.

4. A mineral breaker in accordance with claim 3 wherein a rotary shaft of the switched reluctance motor is coupled to rotatably drive an input shaft of the main drive gear box via a direct mechanical coupling.

5. A mineral breaker in accordance with claim 1 wherein a rotary shaft of the switched reluctance motor is coupled to rotatably drive an input shaft of the main drive gear box by a coupling arrangement comprising a fluid coupling.

6. A mineral breaker in accordance with claim 1 wherein a compliant coupling is provided between a drive shaft of the breaker unit and a corresponding output shaft of the main gear box.

7. A mineral breaker in accordance with claim 6 wherein the compliant coupling is a resilient mechanical coupling.

8. A mineral breaker in accordance with claim 6 wherein the compliant coupling is a grid coupling.

9. A mineral breaker in accordance with claim 1 wherein the breaker unit is a primary, secondary and tertiary crusher for the breaking and in particular the sizing of minerals.

10. A mineral breaker in accordance with claim 1 wherein the breaker unit is selected from roller crushers, jaw crushers, and cone crushers.

11. A mineral breaker in accordance with claim 1 wherein the breaker unit comprises one or more breaker rollers having breaker shafts mounted for rotation and carrying breaking formations on the shafts.

12. A mineral breaker in accordance with claim 11 wherein the breaker unit comprises a plurality of elongate breaker assemblies having breaker shafts mounted for rotation with their axes parallel and carrying breaking formations thereon.

13. A mineral breaker in accordance with claim 11 wherein the breaking formations include outwardly projecting breaker teeth.

14. A mineral breaker in accordance with claim 12 wherein the breaker teeth are arranged to interact to restrict the passageway between the breaker assemblies such that oversized lumps of mineral are prevented from passing therethrough, but to serve to break down these oversized lumps of mineral as the shafts rotate.

15. A mineral breaker in accordance with claim 11 comprising spur gears provided in association with each of a plurality of breaker shafts of a respective plurality of breaker units.

16. A mineral breaker in accordance with claim 15 wherein an extended portion of each breaker shaft carries a spur gear mounted upon it.

17. A mineral breaker in accordance with claim 16 wherein a discrete enclosed volume is provided on the breaker between a working area where the plurality of breaker units are located and the main drive gearbox, an extended portion of each breaker shaft passes into this volume, and spur gears are provided within this enclosed volume carried on respective extended portions of the plurality of breaker shafts.

18. A mineral breaker in accordance with claim 11 comprising a separate timing gearbox having a plurality of output shafts coupled to drive each of a plurality of breaker shaft and at least one input shaft driven by a main gearbox, containing within an enclosed gearbox volume a timing gear assembly comprising mutually engaging spur gears to co-ordinate the rotation of the said output shafts.

19. A mineral breaker in accordance with claim 18 wherein the timing gear assembly comprises a gear shaft for each breaker shaft extending to an output shaft external of the timing gear box coupled with the breaker shaft, the gear shafts associated with each of a respective set of breaker shafts to be timed together carrying mutually engaging spur gears.

20. A mineral breaker in accordance with claim 4, wherein the direct mechanical coupling is a rigid mechanical coupling.
